(19) United States
(12) Patent Application Publication
(10) Pub. No.: US 2019/0202468 A1
(43) Pub. Date: Jul. 4, 2019

(54) VEHICLE CONTROL SYSTEM, VEHICLE CONTROL METHOD, AND STORAGE MEDIUM

(71) Applicant: Honda Motor Co., Ltd., Tokyo (JP)

(72) Inventors: Toshiyuki Kaji, Wako-shi (JP); Yoshifumi Nakamura, Wako-shi (JP)

(21) Appl. No.: 16/232,227

(22) Filed: Dec. 26, 2018

(30) Foreign Application Priority Data
Dec. 28, 2017 (JP) 2017-253187

(51) Int. Cl. B60W 50/08; G06F 16/955; G05D 1/00; B60W 10/20; B60W 10/04; B60W 40/08

(52) U.S. Cl. CPC B60W 50/082; G06F 16/955; G05D 1/0088; B60W 10/20; B60W 2050/007; B60W 40/08; G05D 2201/0213; B60W 2750/308; B60W 2540/30; B60W 10/04

(57) ABSTRACT

A vehicle control system (1) includes: a recognition unit (16) that recognizes surrounding conditions of a host vehicle; a control unit (300) that performs driving support of the host vehicle in a plurality of modes including a first driving mode and a second driving mode with a higher percentage of automation or less required work than that of the first driving mode by controlling one or both of steering and acceleration/deceleration of the host vehicle on the basis of the surrounding conditions recognized by the recognition unit; an acquisition unit that acquires a driving history of an occupant of the host vehicle; and a prohibition unit that prohibits driving support in the second driving mode on the basis of the driving history acquired by the acquisition unit.

### CROSS-REFERENCE TO RELATED APPLICATION

Priority is claimed on Japanese Patent Application No. 2017-253187, filed Dec. 28, 2017, the content of which is incorporated herein by reference.

### BACKGROUND OF THE INVENTION

### Field of the Invention

The invention relates to a vehicle control system, a vehicle control method, and a storage medium.

### Description of Related Art

A technique of causing a vehicle to travel by automatically controlling at least one of acceleration/deceleration and steering of the vehicle (hereinafter referred to as “automated driving”) has been studied. In association therewith, a technique of detecting occurrence of theft or occurrence of abnormality of a vehicle, identifying a position of the vehicle, and limiting traveling of the vehicle is known (for example, see Japanese Unexamined Patent Application, First Publication No. 2005-88760).

### SUMMARY OF THE INVENTION

However, in the technique according to the related art, traveling of a vehicle being limited in consideration of a driving history of an occupant has not been taken into account. As a result, it is possible to cope with malicious driving by a person who has stolen a vehicle or the like but it may not be possible to cope with improper use by an owner of a vehicle or the like.

The invention is made in consideration of the above-mentioned circumstances and an objective thereof is to provide a vehicle control system, a vehicle control method, and a storage medium that can prevent overconfidence in automated driving on the basis of previous driving tendencies of an occupant.

A vehicle control system, a vehicle control method, and a storage medium according to the invention employ the following configurations.

(1) According to an aspect of the invention, there is provided a vehicle control system including: a recognition unit that recognizes surrounding conditions of a host vehicle; a control unit that performs driving support of the host vehicle in a plurality of modes including a first driving mode and a second driving mode with a higher percentage of automation or less required work than that of the first driving mode by controlling one or both of steering and acceleration/deceleration of the host vehicle on the basis of the surrounding conditions recognized by the recognition unit; an acquisition unit that acquires a driving history of an occupant of the host vehicle; and a prohibition unit that prohibits driving support in the second driving mode on the basis of the driving history acquired by the acquisition unit.

(2) In the aspect of (1), the prohibition unit may prohibit driving support in the second driving mode in a case that the driving history acquired by the acquisition unit includes a predetermined history item.

(3) In the aspect of (2), the prohibition unit may prohibit driving support in the second driving mode in a case that the driving history includes the predetermined history item a predetermined number of times or more.

(4) In the aspect of (1), the prohibition unit may prohibit driving support in the second driving mode in a case that the driving history acquired by the acquisition unit includes a predetermined history item.

(5) In the aspect of (4), the first driving mode may be a mode in which driving support of enforcing one of causing an occupant to grip a steering wheel and causing an occupant to observe the surroundings is performed and the second driving mode may be a mode in which driving support in which an occupant does not have to grip a steering wheel or does not have to observe the surroundings is performed.

(6) In the aspect of (4), the prohibition unit may perform at least one of setting an inter-vehicle distance between the host vehicle and a preceding vehicle to be longer than a predetermined value and decreasing an upper limit value of a set speed at the time of traveling at a constant speed in the first driving mode in a case that the driving history acquired by the acquisition unit includes a predetermined driving history.

(7) In the aspect of (4), the prohibition unit may release prohibition of the second driving mode in a case that the occupant has driven normally in the first driving mode over a predetermined distance or a predetermined time.

(8) In the aspect of (2), the predetermined history item may include a history item in which switching from a driving support mode to a manual driving mode has not been performed.

(9) According to another aspect of the invention, there is provided a vehicle control method causing a computer to perform: recognizing surrounding conditions of a host vehicle; performing driving support of the host vehicle in a plurality of modes including a first driving mode and a second driving mode with a higher percentage of automation or less required work than that of the first driving mode by controlling one or both of steering and acceleration/deceleration of the host vehicle on the basis of the recognized surrounding conditions; acquiring a driving history of an occupant of the host vehicle; and prohibiting driving support in the second driving mode on the basis of the acquired driving history.

(10) According to another aspect of the invention, there is provided a non-transitory computer-readable storage medium having a program stored therein, the program causing a computer to perform: recognizing surrounding conditions of a host vehicle; performing driving support of the host vehicle in a plurality of modes including a first driving mode and a second driving mode with a higher percentage of automation or less required work than that of the first driving mode by controlling one or both of steering and acceleration/deceleration of the host vehicle on the basis of the recognized surrounding conditions; acquiring a driving history of an occupant of the host vehicle; and prohibiting driving support in the second driving mode on the basis of the acquired driving history.

According to the aspects of (1), (2), (3), (9), and (10), it is possible to prevent overconfidence in automated driving on the basis of previous driving tendencies of an occupant.

According to the aspects of (4), (5), and (6), it is possible to change details of driving support depending on a driving skill of an occupant.

According to the aspect of (7), it is possible to improve consciousness during driving of an occupant by releasing prohibition of driving support in a case that a driving skill of an occupant has been improved.

### BRIEF DESCRIPTION OF THE DRAWINGS

FIG. 1 is a diagram showing a configuration of a vehicle control system 1 according to a first embodiment;

FIG. 2 is a diagram showing an example of a configuration of a switching control unit;

FIG. 3 is a diagram showing an example of history information on a predetermined history item of an occupant which is generated by an information acquiring unit;

FIG. 4 is a diagram showing an example of driving support information of which an occupant is notified;

FIG. 5 is a diagram showing an example of driving support information of which an occupant is notified;

FIG. 6 is a flowchart showing an example of a flow of a routine which is performed in the vehicle control system; and

FIG. 7 is a diagram showing an example of a hardware configuration of an automated driving prohibiting unit according to the first embodiment.

### DETAILED DESCRIPTION OF THE INVENTION

Hereinafter, a vehicle control system, a vehicle control method, and a storage medium according to an embodiment of the invention will be described with reference to the accompanying drawings. A vehicle control system according to an embodiment performs, for example, driving support including automated driving. Automated driving means that a vehicle is caused to travel by performing one or both of steering control and speed control independently of an occupant's operation. An “occupant” in this embodiment refers to an occupant who sits, for example, on a driver's seat, that is, a seat in which a driving elements is provided. In the embodiment, driving support includes a first driving mode and a second driving mode in which a percentage of automation of driving support is higher than that of the first driving mode or required work is less than that of the first driving mode. In the second driving mode, an occupant does not operate the driving elements of the vehicle, at least one of acceleration/deceleration and steering of the vehicle is automatically controlled, and automated driving is performed.

The driving support may include various control modes in addition to the first driving mode and the second driving mode for automated driving in which an operation of the driving elements 80 is not required. In this embodiment, driving support in the second driving mode associates with automated driving.

From another viewpoint, the first driving mode is a driving mode in which one of causing an occupant to grip a steering wheel and causing an occupant to observe the surroundings is enforced. The second driving mode is a driving mode in which an occupant does not need to grip a steering wheel and the occupant does not need to observe the surroundings.

Driving support patterns will be described below. Two examples are conceivable for driving support.

### FIRST EXAMPLE

The first driving mode is, for example, a mode in which manual driving is basically performed and driving support such as that of an adaptive cruise control system (ACC) or a lane keeping assistance system (LKAS) is performed. In the first driving mode, an occupant grips a steering wheel in the same way as in manual driving and driving support of enforcing a high level of duty for surroundings observation for movement of nearby vehicles or the like is performed.

The second driving mode is a mode in which driving support such as that of an ACC or an LKAS is automatically performed. In the second driving mode, an occupant does not grip a steering wheel and driving support of enforcing a low level of duty for surroundings observation for movement of nearby vehicles or the like is performed.

### SECOND EXAMPLE

The first driving mode is, for example, a mode in which automated driving such as that of an ACC or an LKAS is performed on a ramp of an expressway or a regular road. In the first driving mode, an occupant grips a steering wheel in the same way as in manual driving and driving support of enforcing a high level of duty for surroundings observation for movement of a nearby vehicle or the like is performed.

The second driving mode is, for example, a mode in which driving support such as following traveling on an expressway is automatically performed. In the second driving mode, an occupant does not grip a steering wheel and driving support of enforcing a low level of duty for surroundings observation for movement of a nearby vehicle or the like is performed.

### First Embodiment

The first example will be described in the following description.

[Entire Configuration]

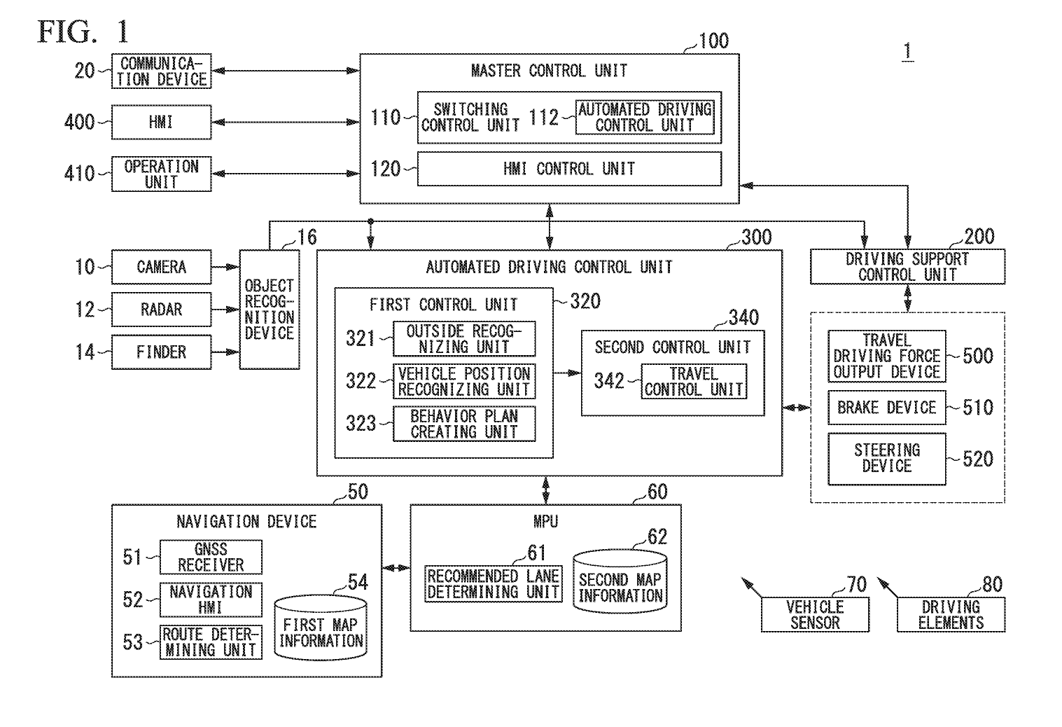

FIG. 1 is a diagram showing a configuration of a vehicle control system 1 according to the first embodiment. A vehicle (hereinafter referred to as a host vehicle) in which the vehicle control system 1 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to an internal combustion engine or electric power which is discharged from a secondary battery or a fuel cell.

The vehicle control system 1 includes, for example, a camera 10, a radar 12, a finder 14, an object recognition device 16, a communication device 20, a navigation device 50, a map positioning unit (MPU) 60, a vehicle sensor 70, a driving elements 80, a vehicle interior camera 90, a master control unit 100, a driving support control unit 200, an automated driving control unit 300, a human-machine interface (HMI) 400, an operation unit 410, a travel driving force output device 500, a brake device 510, and a steering device 520. These devices or units are connected to each other via a multiplex communication line such as a controller area network (CAN) communication line, a serial communication line, a radio communication network, or the like. The configuration shown in FIG. 1 is only an example and a part of the configuration may be omitted or another configuration may be added thereto.

The camera 10 images the surroundings of the host vehicle and generates a captured image. The camera 10 is, for example, a digital camera using a solid-state imaging device such as a charge coupled device (CCD) or a complementary metal oxide semiconductor (CMOS). The camera 10 is attached to arbitrary positions of the host vehicle in which the vehicle control system 1 is mounted. The surroundings of the host vehicle includes a front scene of the host vehicle and may include a lateral scene or a rear scene of the host vehicle. In a case that a front scene is imaged, the camera 10 is attached to an upper part of a front windshield, a rear surface of a rearview mirror, or the like. In a case that a rear scene is imaged, the camera 10 is attached to an upper part of a rear windshield, a backdoor, or the like. In a case that a side scene is imaged, the camera 10 is attached to a door mirror or the like. The camera 10 images the surroundings of the host vehicle, for example, periodically and repeatedly. The camera 10 may be a stereoscopic camera.

The radar 12 radiates radio waves such as millimeter waves to the surroundings of the host vehicle, detects radio waves (reflected waves) reflected by an object, and detects at least a position (a distance and a direction) of the object. One or more radars 12 are attached to arbitrary positions in the host vehicle. The radar 12 may detect a position and a speed of an object using a frequency modulated continuous wave (FM-CW) method.

The finder 14 is a light detection and ranging or laser imaging detection and ranging device (LIDAR) that measures scattered light in response to applied light and detects a distance to an object. One or more finders 14 are attached to arbitrary positions of the host vehicle.

The object recognition device 16 performs sensor fusion processing on the detection results from some or all of the camera 10, the radar 12, and the finder 14 and recognizes a position, a type, a speed, and the like of an object. The object recognition device 16 outputs the recognition results to the driving support control unit 200 and the automated driving control unit 300. The object recognition device 16 is an example of a recognition unit.

The communication device 20 communicates with other vehicles near the host vehicle, for example, using a cellular network, a Wi-Fi (registered trademark) network, Bluetooth (registered trademark), or a dedicated short range communication (DSRC) or communicates with various servers via a radio base station. The communication device 20 communicates with a terminal device which is carried by a person outside the vehicle.

The navigation device 50 includes, for example, a global navigation satellite system (GNSS) receiver 51, a navigation HMI 52, and a route determining unit 53, and stores first map information 54 in a storage device such as a hard disk drive (HDD) or a flash memory. The GNSS receiver 51 specifies a position of the host vehicle on the basis of signals received from GNSS satellites. The position of the host vehicle may be specified or complemented by an inertial navigation system (INS) using the output of the vehicle sensor 70. The navigation HMI 52 includes a display device, a speaker, a touch panel, and keys. All or a part of the navigation HMI 52 may be shared by the HMI 400 which will be described later.

For example, the route determining unit 53 determines a route (for example, which includes information on transit points to a destination) from the position of the host vehicle (or an input arbitrary position) specified by the GNSS receiver 51 to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route determined by the route determining unit 53 is output to the MPU 60. The navigation device 50 may perform route guidance using the navigation HMI 52 on the basis of the route determined by the route determining unit 53.

The MPU 60 serves as, for example, a recommended lane determining unit 61 and stores second map information 62 in a storage device such as an HDD or a flash memory. The recommended lane determining unit 61 divides a route supplied from the navigation device 50 into a plurality of blocks and determines a recommended lane for each block with reference to the second map information 62.

The second map information 62 is map information with higher precision than that of the first map information 54. The second map information 62 includes, for example, information of the center of a lane, information of boundaries of a lane, road information, traffic regulation information, address information, facility information, and phone number information. The second map information 62 may include information on sections in which lane change is possible or sections in which overtaking is possible.

The vehicle sensor 70 includes a vehicle speed sensor that detects a speed of the host vehicle, an acceleration sensor that detects acceleration, a yaw rate sensor that detects an angular velocity around a vertical axis, and a direction sensor that detects a direction of the host vehicle.

The driving elements 80 includes, for example, an accelerator pedal, a brake pedal, a shift lever, a steering wheel, and other elements. A sensor that detects an amount of operation or performing of an operation is attached to the driving elements 80, and detection results thereof are output to one or more of the master control unit 100, the driving support control unit 200, the automated driving control unit 300, the travel driving force output device 500, the brake device 510, and the steering device 520.

[Master Control Unit]

The master control unit 100 includes, for example, a switching control unit 110 and an HMI control unit 120. These elements are embodied, for example, by causing a hardware processor such as a central processing unit (CPU) to execute a program (software). A part or all of these elements may be embodied in hardware (which includes circuitry) such as a large scale integration (LSI), an application specific integrated circuit (ASIC), a field-programmable gate array (FPGA), or a graphics processing unit (GPU), or may be embodied in cooperation of software and hardware. The program may be stored in a storage device such as a hard disk drive (HDD) or a flash memory in advance, may be stored in a detachable storage medium such as a DVD or a CD-ROM, or may be installed in the storage device by attaching the storage medium to a drive device.

The switching control unit 110 switches a driving mode for driving support, for example, on the basis of an operation signal which is input from a predetermined switch included in the HMI 400. The switching control unit 110 further includes an automated driving prohibiting unit 112 that prohibits switching of the driving mode for driving support.

The switching control unit 110 may cancel driving support and switch the driving mode to manual driving, for example, on the basis of an operation for instructing acceleration, deceleration, or steering to the driving elements 80 such as an accelerator pedal, a brake pedal, or a steering wheel.

The switching control unit 110 may switch the driving mode for driving support on the basis of a behavior plan which is created by a behavior plan creating unit 323.

For example, the switching control unit 110 may end driving support at a point at which automated driving is scheduled to end and which is defined in the behavior plan. The switching control unit 110 causes the automated driving prohibiting unit 112 to determine whether switching of driving support is to be performed before the driving mode for driving support is switched. In a case that a positive determination result for switching of driving support is acquired from the automated driving prohibiting unit 112, the switching control unit 110 performs switching of driving support.

In a case that a negative determination result for switching of driving support is acquired from the automated driving prohibiting unit 112, the switching control unit 110 does not perform switching from the first driving mode to the second driving mode.

Details of the function of the switching control unit 110 will be described later.

The HMI control unit 120 causes the HMI 400 to output information on the driving mode for driving support and a notification associated with switching of the driving mode. The HMI control unit 120 may output information received by the HMI 400 to one or both of the driving support control unit 200 and the automated driving control unit 300. Details of the function of the HMI control unit 120 will be described later.

[Driving Support Control Unit]

The driving support control unit 200 performs driving support in the first driving mode and the second driving mode in response to an instruction from the master control unit 100. The driving support control unit 200 performs driving support such as that of an ACC or an LKAS. For example, in a case that the ACC is performed, the driving support control unit 200 controls the travel driving force output device 500 and the brake device 510 such that the host vehicle M travels in a state in which an inter-vehicle distance from a preceding vehicle is kept constant on the basis of information input from the camera 10, the radar 12, and the finder 14 via the object recognition device 16. That is, the driving support control unit 200 performs acceleration/deceleration control (speed control) based on the inter-vehicle distance from a preceding vehicle.

In a case that the LKAS is performed, the driving support control unit 200 controls the steering device 520 such that the host vehicle M travels while keeping a traveling lane on which the host vehicle is currently traveling (lane keep). That is, the driving support control unit 200 performs steering control for keeping a lane. The driving support mode may include various control modes in addition to the first driving mode and the second driving mode.

[Automated Driving Control Unit]

The automated driving control unit 300 performs, for example, driving support in the first driving mode and the second driving mode. For example, in a case that the ACC is performed, the automated driving control unit 300 controls the travel driving force output device 500 and the brake device 510 such that the host vehicle travels in a state in which an inter-vehicle distance from a preceding vehicle is kept constant on the basis of information input from the camera 10, the radar 12, and the finder 14 via the object recognition device 16. That is, the automated driving control unit 300 performs acceleration/deceleration control (speed control) based on the inter-vehicle distance from a preceding vehicle.

The automated driving control unit 300 includes, for example, a first control unit 320 and a second control unit 340. The first control unit 320 and the second control unit 340 are embodied by causing a processor such as a CPU to execute a program. Some or all of such functional units may be embodied in hardware such as an LSI, an ASIC, or an FPGA or may be embodied in cooperation of software and hardware. The first control unit 320 and the second control unit 340 are an example of a control unit together.

The first control unit 320 includes, for example, an outside recognizing unit 321, a vehicle position recognizing unit 322, and a behavior plan creating unit 323. The outside recognizing unit 321 recognizes states such as positions, speeds, and accelerations of neighboring vehicles on the basis of information input from the camera 10, the radar 12, and the finder 14 via the object recognition device 16. A position of a neighboring vehicle may be expressed by a representative point such as the center of gravity or corners of the neighboring vehicle or may be expressed by an area which is marked by an outline of the neighboring vehicle. A “state” of a neighboring vehicle may include an acceleration, a jerk, or a “behavior status” (for example, whether lane change is being performed or is intended) of the neighboring vehicle.

The outside recognizing unit 321 may recognize at least one of a neighboring vehicle, an obstacle (for example, guard rails, utility poles, parked vehicles, or persons such as pedestrians), a road shape, and other object.

The vehicle position recognizing unit 322 recognizes, for example, a lane (a traveling lane) on which the host vehicle M is traveling and a position and a posture of the host vehicle relative to the traveling lane. The vehicle position recognizing unit 322 recognizes the traveling lane, for example, by comparing a pattern of road defining lines around the host vehicle which is recognized from an image captured by the camera 10 with a pattern of road defining lines (for example, arrangements of solid lines and dotted lines) which is acquired from the second map information 62. The vehicle position recognizing unit 322 may recognize the position or the posture of the host vehicle relative to the traveling lane.

The behavior plan creating unit 323 creates a behavior plan for causing the host vehicle to execute automated driving to a destination or the like. For example, the behavior plan creating unit 323 determines events which are sequentially performed in automated driving control such that the host vehicle travels in a recommended lane determined by the recommended lane determining unit 61 and can cope with surrounding conditions of the host vehicle. Examples of the events in automated driving include a constant-speed traveling event in which a vehicle travels in the same traveling lane at a constant speed, a low-speed following traveling event in which a vehicle travels to follow a preceding vehicle at a low speed (for example, 40 [km/h]), a lane change event in which a host vehicle changes a traveling lane, an overtaking event in which a vehicle overtakes a preceding vehicle, a merging event in which a host vehicle travels to merge at a merging point, a branching event in which a host vehicle travels to a destination at a junction of a road, and an emergency stop event in which a host vehicle stops emergently.

In the course of execution of such events, behavior for avoidance may be planned on the basis of surrounding conditions of the host vehicle (such as presence of a neighboring vehicle or a pedestrian and lane narrowing due to road work). The behavior plan creating unit 323 creates a target track in which the host vehicle will travel in correlation with the above-mentioned various events. A target track is expressed by sequentially arranging points (track points) at which the host vehicle will arrive.

The second control unit 340 includes, for example, a traveling control unit 342. The traveling control unit 342 controls the travel driving force output device 500, the brake device 510, and the steering device 520 such that the host vehicle passes through the target track created by the behavior plan creating unit 323 as scheduled.

The HMI 400 presents a variety of information to an occupant in the vehicle and receives an input operation from the occupant. The HMI 400 includes, for example, some or all of various display devices, a light emitting units, a speaker, a buzzer, a touch panel, various operation switches, and keys. Details of the function of the HMI 400 will be described later.

The travel driving force output device 500 outputs a travel driving force (a torque) for allowing the host vehicle to travel to driving wheels. The travel driving force output device 500 includes, for example, a combination of an internal combustion engine, an electric motor, and a transmission and an electronic control unit (ECU) that controls them. The brake device 510 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the traveling control unit 342 or information input from the driving elements 80 such that a brake torque based on a braking operation is output to vehicle wheels. The steering device 520 includes, for example, a steering ECU and an electric motor. The steering ECU drives the electric motor on the basis of information input from the traveling control unit 342 or information input from the driving elements 80 to change the direction of turning wheels.

The operation unit 410 is provided, for example, in a steering wheel which is one of the driving elements 80. A grip sensor (not shown) that detects a grip of the steering wheel by an occupant may be provided in the steering wheel. The operation unit 410 includes, for example, a switch that switches between start and end of driving support and switches a driving mode for driving support. The operation unit 410 outputs information on switching between start and end of driving support or switching of the driving mode for driving support to the switching control unit 110 by receiving a switch operation from an occupant.

[Configuration of Switching Control Unit]

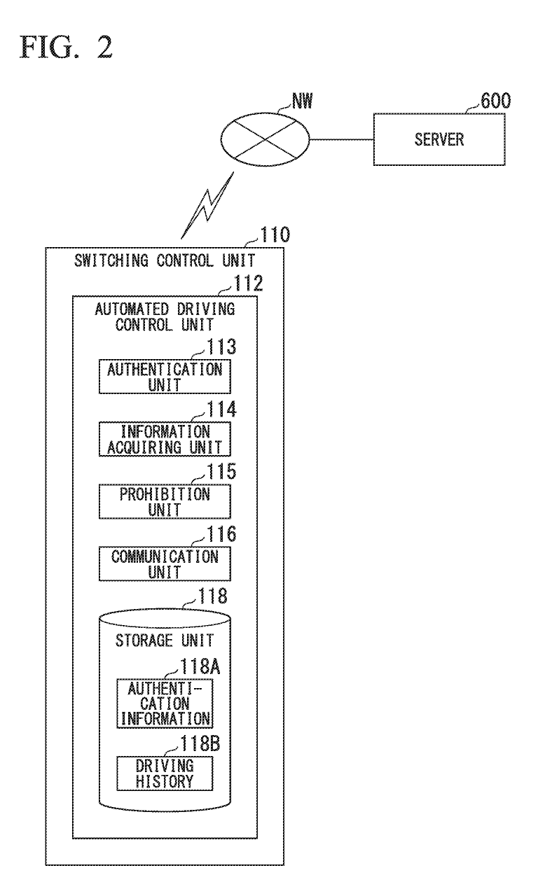

FIG. 2 is a diagram showing an example of a configuration of the switching control unit 110. The switching control unit 110 includes an automated driving prohibiting unit 112.

The automated driving prohibiting unit 112 includes, for example, an authentication unit 113, an information acquiring unit 114, a prohibition unit 115, a communication unit 116, and a storage unit 118. The authentication unit 113, the information acquiring unit 114, the prohibition unit 115, and the communication unit 116 are embodied, for example, by causing a hardware processor such as a CPU to execute a program. Some or all of these elements may be embodied in hardware such as an LSI, an ASIC, an FPGA, or a GPU or may be embodied in cooperation of software and hardware.

The communication unit 116 communicates with another vehicle which is present near the host vehicle, for example, using a cellular network, a Wi-Fi (registered trademark) network, a Bluetooth (registered trademark), or a dedicated short range communication (DSRC) via the communication device 20 or communicates with various servers via a radio base station.

The storage unit 118 is embodied by an HDD, a flash memory, a random access memory (RAM), a read only memory (ROM), or the like. For example, authentication information 118A for authenticating an occupant and a driving history 118B in the past of the occupant are stored in the storage unit 118. The driving history 118B may be stored in the storage unit 118 at a predetermined time in synchronization with traveling of the host vehicle or may be stored in a server 600 by communication with the server 600.

The authentication unit 113 authenticates whether an occupant is a user registered in advance. The authentication unit 113 communicates, for example, with a terminal device which is carried by the occupant, determines whether input information such as an ID and a password input to the terminal device by the occupant coincides with the authentication information 118A of the occupant stored in the storage unit 118 in advance, and authenticates the occupant in a case that the determination result is positive.

The authentication unit 113 may communicate with a terminal device which is carried by an occupant and may authenticate the occupant using user authentication functions such as biometric authentication functions such as a face authentication function, a fingerprint authentication function, and a voice authentication function of the terminal device. These authentication functions may be provided in the host vehicle. In a case that the occupant is authenticated by the authentication unit 113, the occupant can start use of the host vehicle.

The information acquiring unit 114 acquires the driving history 118B in the past of the occupant with reference to the storage unit 118 on the basis of the result indicating that the authentication unit 113 has authenticated the occupant. The information acquiring unit 114 extracts a predetermined history item from the driving history 118B in the past of the occupant on the basis of the driving history 118B in the past of the occupant. The predetermined history item is, for example, a history of an action based on intention or mistake which was performed by the occupant. Examples of an action based on intention or mistake include overspeed driving, tailgating driving, sudden lane change, sudden acceleration, shoulder traveling, reverse traveling, hit-and-run accident, hit-and-run, drunken driving, unlicensed driving, carelessness in automated driving, software modification of a vehicle, vehicle remodeling, illegal parking, signal ignorance, and driving of a vehicle with expired safety inspection. The predetermined history item includes a history item in which switching of a state in which a driving support mode including the first driving mode and the second driving mode is executed to a manual driving mode has not been correctly performed or a history in which a minimum risk maneuver (MRM) for reducing a risk or the like has occurred. The predetermined history item includes a notification history of notification of an action based on intention or mistake of the occupant from another vehicle or another person to the police or the like. The notification history may be, for example, to specify an occupant or a vehicle by notifying a vehicle number.

For example, in a case that a vehicle is intended to switch to a manual driving mode while the vehicle is traveling in the driving support mode including the first driving mode and the second driving mode and switching to the manual driving mode has been stopped due to an action based on mistake such as drowsiness of the occupant, a history of occurrence of MRM is stored in the storage unit 118.

The information acquiring unit 114 may communicate with the server 600 and acquire the driving history 118B in the past of the occupant. The server 600 stores, for example, a predetermined history item of the occupant associated with the host vehicle which is not stored in the host vehicle. The server 600 is provided, for example, in a vehicle dealer, stores information on maintenance histories, and provides predetermined histories such as software modification, vehicle remodeling, vehicle inspection records of the host vehicle in the past of the occupant. The server 600 may be provided in an agent supplied with information from the police or an insurance company, or may provide information of offense histories of occupants.

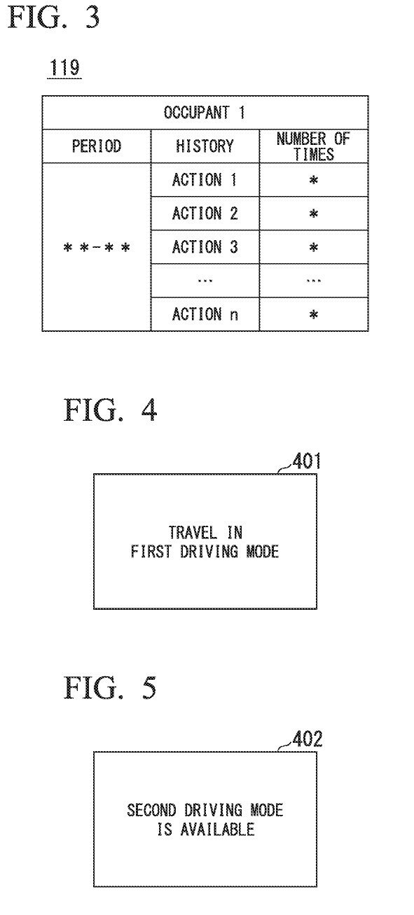

FIG. 3 is a diagram showing an example of history information 119 on the predetermined history item of the occupant which is generated by the information acquiring unit 114. The information acquiring unit 114 calculates the number of times of each action which was performed in the past by the occupant on the basis of the acquired history of action based on intention or mistake and generates the history information 119. The history information 119 is information in which the history of an action which was performed in a predetermined period in the past by the occupant is correlated with the number of times thereof. The information acquiring unit 114 stores the history information 119 in the storage unit 118.

The prohibition unit 115 prohibits driving support for the host vehicle. The prohibition unit 115 starts a determination process of determining whether a degree of driving support may be switched on the basis of an inquiry from the switching control unit 110. In a case that it is determined that the degree of driving support may be switched on the basis of the driving history of the occupant, the prohibition unit 115 instructs the switching control unit 110 to perform switching of driving support.

The prohibition unit 115 determines whether each action included in the history of actions based on intention or mistake in a predetermined period of the past is equal to or greater than a predetermined number of times on the basis of the history information 119 stored in the storage unit 118. The predetermined number of times may be set on the basis of a degree of intention or mistake of each action. At this time, in a case that the determination result for at least one of the actions is positive, the prohibition unit 115 prohibits driving support. For example, the prohibition unit 115 outputs an instruction to the driving support control unit 200 such that control details of driving support in the first driving mode are prohibited.

The prohibition unit 115 causes the driving support control unit 200 to control the travel driving force output device 500, the brake device 510, and the steering device 520 such that the inter-vehicle distance between the host vehicle and a preceding vehicle in control details of the ACC in the first driving mode is set to be longer than a predetermined distance. In addition, the prohibition unit 115 causes the driving support control unit 200 to control the travel driving force output device 500, the brake device 510, and the steering device 520 such that an upper limit of a set speed at the time of traveling at a constant speed in the control details of the ACC in the first driving mode decreases.

The prohibition unit 115 determines whether an inquiry about switching of driving support has been transmitted from the switching control unit 110, for example, in a state in which prohibition of driving support was being performed, and outputs an instruction to the switching control unit 110 such that switching from the first driving mode to the second driving mode is prohibited in a case that the determination result is positive.

Even in a case that the first driving mode and the second driving mode are prohibited, the prohibition unit 115 does not prohibit functions associated with protection of an occupant or a pedestrian such as a collision mitigation brake system (CMBS) or a pretensioner function of a seat belt. Alternatively, in a case that the first driving mode and the second driving mode are prohibited, the prohibition unit 115 may perform control such that protection of an occupant or a pedestrian is further enhanced.

In a case that an instruction is acquired from the prohibition unit 115, the switching control unit 110 prohibits switching from the first driving mode to the second driving mode and maintains the first driving mode. At this time, the HMI control unit 120 may notify an occupant of information indicating that the first driving mode is maintained via the HMI 400. FIG. 4 is a diagram showing an example of an image 401 for notifying an occupant that the first driving mode is maintained.

In a case that an occupant has performed normal driving in which the actions included in the predetermined history item are not performed over a predetermined distance or a predetermined time in the first driving mode in a state in which prohibition of driving support is maintained from past traveling, the prohibition unit 115 may release prohibition of driving support. The prohibition unit 115 determines whether a traveling distance or time from a time point at which prohibition of driving support has been started is equal to or greater than a preset reference. In a case that the determination result is positive, the prohibition unit 115 returns the inter-vehicle distance between the host vehicle and a preceding vehicle and the upper limit of the set speed at the time of traveling at a constant speed in control details of the ACC in the first driving mode to values before the prohibition. Then, the prohibition unit 115 releases prohibition of switching from the first driving mode to the second driving mode.

At this time, the HMI control unit 120 may notify the occupant of information indicating that prohibition of driving support has been released via the HMI 400. FIG. 5 is a diagram showing an example of an image 402 for notifying an occupant that prohibition of driving support has been released. After the prohibition has been released, the occupant can perform the second driving mode.

For example, in a case that it is detected that the occupant does not carry out the duty of care such as not gripping a steering wheel or not observing the surroundings in the first driving mode on the basis of detection results from the driving elements 80, the prohibition unit 115 instructs the switching control unit 110 to switch the driving mode to the second driving mode. In a case that the driving support mode is switched to the manual driving mode and it is detected that the occupant cannot drive manually on the basis of detection results from the driving elements 80, the prohibition unit 115 instructs the switching control unit 110 to stop switching to the manual driving mode. In a case that switching of the driving mode is not normally performed, the automated driving prohibiting unit 112 stores the history in the storage unit 118.

[Process Flow]

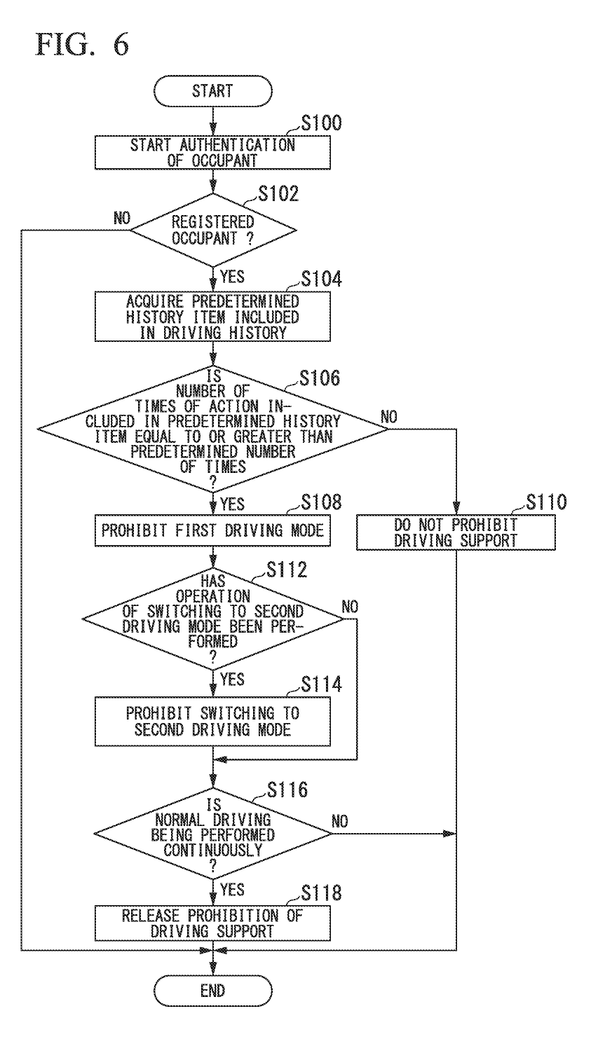

A process which is performed in the vehicle control system 1 will be described below. FIG. 6 is a flowchart showing an example of a process flow which is performed in the vehicle control system 1. The authentication unit 113 receives authentication information input by allowing an occupant to operate a mobile terminal or an operation unit of the host vehicle and starts authentication (Step S100). The authentication unit 113 authenticates whether the occupant is an occupant registered in advance (Step S102).

In a case that the determination result of Step S102 is positive, the information acquiring unit 114 acquires the driving history 118B in the past of the occupant with reference to the storage unit 118 (Step S104). In a case that the determination result of Step S102 is negative, the vehicle control system 1 ends the process flow in the flowchart. The information acquiring unit 114 extracts a predetermined history item from the driving history 118B in the past of the occupant acquired in Step S104. The prohibition unit 115 determines whether the number of times of each action included in a predetermined history item in a predetermined period of the past is equal to or greater than a predetermined number of times on the basis of the predetermined history item extracted by the information acquiring unit 114 (Step S106).

In a case that the determination result of Step S106 is negative, the prohibition unit 115 does not prohibit driving support (Step S110) and the process flow in the flowchart ends. In a case that the determination result of Step S106 is positive, the prohibition unit 115 prohibits the first driving mode (Step S108).

The prohibition unit 115 determines whether an inquiry about switching of driving support has been transmitted from the switching control unit 110 on the basis of the occupant's operation (Step S112). In a case that the determination result of Step S112 is positive, the prohibition unit 115 prohibits switching from the first driving mode to the second driving mode (Step S114). In a case that the determination result of Step S112 is negative, the prohibition unit 115 causes the process flow to transition to Step S116.

The prohibition unit 115 determines whether the occupant carries out normal driving continuously over a predetermined distance or a predetermined time in the first driving mode (Step S116). In a case that the determination result of Step S116 is negative, the process flow in the flowchart ends. In a case that the determination result of Step S116 is positive, the prohibition unit 115 releases prohibition of driving support (Step S118). After this step has been performed, the process flow in the flowchart ends. According to the first embodiment described above, the vehicle control system 1 can prevent overconfidence in automated driving support on the basis of a previous driving tendencies of an occupant. The vehicle control system 1 can prohibit driving support for a host vehicle according to a driving skill of an occupant and release prohibition of driving support with improvement of the driving skill of the occupant.

[Hardware Configuration]

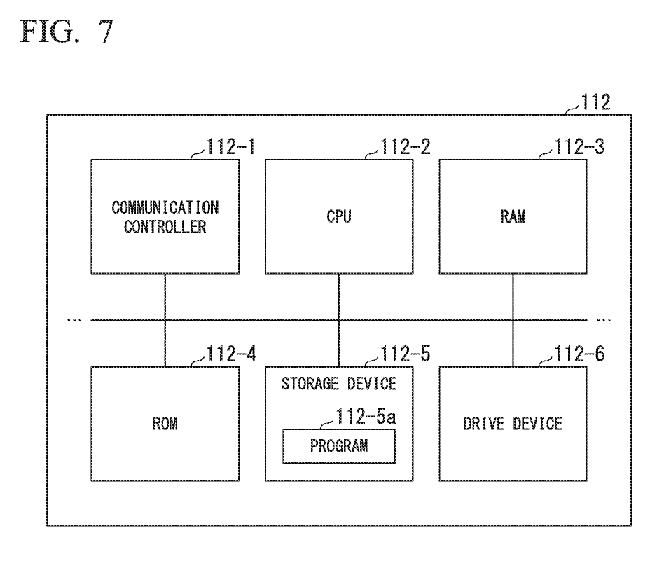

The automated driving prohibiting unit 112 of the vehicle control system according to the first embodiment is embodied, for example, by a hardware configuration shown in FIG. 7. FIG. 7 is a diagram showing an example of the hardware configuration of the automated driving prohibiting unit 112 according to the embodiment. The automated driving prohibiting unit 112 has a configuration in which a communication controller 112-1, a CPU 112-2, a RAM 112-3, a ROM 112-4, a secondary storage device 112-5 such as a flash memory or an HDD, and a drive device 112-6 are connected to each other via an internal bus or a dedicated communication line. A portable storage medium such as an optical disc is attached to the drive device 112-6. In a case that a program 112-5a stored in the secondary storage device 112-5 is loaded into the RAM 112-3 by a DMA controller (not shown) or the like and is executed by the CPU 112-2, the functional units of the automated driving prohibiting unit 112 are embodied. The program which is referred to by the CPU 112-2 may be stored in the portable storage medium attached to the drive device 112-6 or may be downloaded from another device via a network NW.

The above-mentioned embodiment can be expressed as follows: A vehicle control system including a storage device and a hardware processor that executes a program stored in the storage device, wherein the hardware processor is configured to recognize surrounding conditions of a host vehicle, to performing driving support of the host vehicle in a plurality of modes including a first driving mode and a second driving mode with a higher percentage of automation or less required work than that of the first driving mode by controlling one or both of steering and acceleration/deceleration of the host vehicle on the basis of the recognized surrounding conditions, to acquire a driving history of an occupant of the host vehicle, and to prohibit driving support in the second driving mode on the basis of the acquired driving history, by executing the program.

### Second Embodiment

The second example will be described below. As described above, in the first example, driving support in the first driving mode is basically performed in manual driving and the driving support in the second driving mode is performed in automated driving. In the second example, driving support in the first driving mode and the second driving mode is performed in automated driving. In the following description, the same elements as in the first embodiment will be referred to by the same names and reference signs and description thereof will not be repeated.

The prohibition unit 115 determines whether the number of time of each action included in a history of actions based on intention or mistake in a predetermined period of the past is equal to or greater than a predetermined number of times on the basis of the history information 119 stored in the storage unit 118, and prohibits control details of driving support in the first driving mode in a case that the determination result of at least one action is positive.

The prohibition unit 115 prohibits driving support such as that of an ACC or an LKAS from being performed in automated driving and allows driving support based on manual driving to be performed. The prohibition unit 115 causes the driving support control unit 200 to control the travel driving force output device 500, the brake device 510, and the steering device 520 such that the inter-vehicle distance between a preceding vehicle and a host vehicle in control details of the ACC is equal to or greater than a predetermined value. In addition, the prohibition unit 115 causes the driving support control unit 200 to control the travel driving force output device 500, the brake device 510, and the steering device 520 such that the upper limit of a set speed at the time of traveling at a constant speed in the control details of the ACC decreases.

According to the above-mentioned second embodiment, the vehicle control system 1 can limit automated driving support to manual driving on the basis of previous driving tendencies of an occupant and prevent overconfidence in automated driving support.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognition unit that recognizes surrounding conditions of a host vehicle;
a control unit that performs driving support of the host vehicle in a plurality of modes including a first driving mode and a second driving mode with a higher percentage of automation or less required work than that of the first driving mode by controlling one or both of steering and acceleration/deceleration of the host vehicle on the basis of the surrounding conditions recognized by the recognition unit;
an acquisition unit that acquires a driving history of an occupant of the host vehicle; and
a prohibition unit that prohibits driving support in the second driving mode on the basis of the driving history acquired by the acquisition unit.

2. The vehicle control system according to claim 1, wherein the prohibition unit prohibits driving support in the second driving mode in a case that the driving history acquired by the acquisition unit includes a predetermined history item.

3. The vehicle control system according to claim 2, wherein the prohibition unit prohibits driving support in the second driving mode in a case that the driving history includes the predetermined history item a predetermined number of times or more.

4. The vehicle control system according to claim 1, wherein the prohibition unit prohibits driving support in the second driving mode in a case that the driving history acquired by the acquisition unit includes a predetermined history item.

5. The vehicle control system according to claim 4, wherein the first driving mode is a mode in which driving support of enforcing one of causing an occupant to grip a steering wheel and causing an occupant to observe the surroundings is performed and the second driving mode is a mode in which driving support in which an occupant does not have to grip a steering wheel or does not have to observe the surroundings is performed.

6. The vehicle control system according to claim 4, wherein the prohibition unit performs at least one of setting an inter-vehicle distance between the host vehicle and a preceding vehicle to be longer than a predetermined value and decreasing an upper limit value of a set speed at the time of traveling at a constant speed in the first driving mode in a case that the driving history acquired by the acquisition unit includes a predetermined driving history.

7. The vehicle control system according to claim 4, wherein the prohibition unit releases prohibition of the second driving mode in a case that the occupant has driven normally in the first driving mode over a predetermined distance or a predetermined time.

8. The vehicle control system according to claim 2, wherein the predetermined history item includes a history item in which switching from a driving support mode to a manual driving mode has not been performed.

9. A vehicle control method causing a computer to perform:
recognizing surrounding conditions of a host vehicle;
performing driving support of the host vehicle in a plurality of modes including a first driving mode and a second driving mode with a higher percentage of automation or less required work than that of the first driving mode by controlling one or both of steering and acceleration/deceleration of the host vehicle on the basis of the recognized surrounding conditions;
acquiring a driving history of an occupant of the host vehicle; and
prohibiting driving support in the second driving mode on the basis of the acquired driving history.

10. A non-transitory computer-readable storage medium having a program stored therein, the program causing a computer to perform:
recognizing surrounding conditions of a host vehicle;
performing driving support of the host vehicle in a plurality of modes including a first driving mode and a second driving mode with a higher percentage of automation or less required work than that of the first driving mode by controlling one or both of steering and acceleration/deceleration of the host vehicle on the basis of the recognized surrounding conditions;
acquiring a driving history of an occupant of the host vehicle; and
prohibiting driving support in the second driving mode on the basis of the acquired driving history.
